(19) United States
(12) Patent Application Publication
(10) Pub. No.: US 2023/0263227 A1
(43) Pub. Date: Aug. 24, 2023

(54) Heater Device Component

(71) Applicant: JT International SA, Geneva (CH)

(72) Inventors: Olayiwola Olamiposi Popoola, Walton-on-Thames (GB); Alec Wright, Guildford (GB); Andrew Robert John Rogan, Forres (GB); Kyle Adair, Lisburn (GB); Gordon Montgomery, Ballymena (GB)

(73) Assignee: JT International SA, Geneva (CH)

(21) Appl. No.: 18/018,184

(22) PCT Filed: Jul. 27, 2021
(86) PCT No.: PCT/EP2021/071017

§ 371 Date: Jan. 26, 2023

(30) Foreign Application Priority Data
Jul. 29, 2020 (EP) 20188457.4

(51) Int. Cl. A24F 40/46; A24F 40/10; A24F 40/48

(52) U.S. Cl. CPC A24F 40/46; A24F 40/10; A24F 40/48

(57) ABSTRACT

A heater device for an electronic cigarette includes: a heater unit housing a vaporising chamber and arranged to vaporise a liquid received from a liquid reservoir and generate a vapour; and a vapour flow path extending from the vaporising chamber arranged to fluidly communicate with a mouthpiece of an electronic cigarette to allow the generated vapour to flow from the vaporising chamber to the mouthpiece. The heater unit includes a plurality of through-channels arranged to allow the generated vapour to flow from the vaporising chamber to the vapour flow path.

### FIELD OF INVENTION

The present invention relates to vapour generation devices, and more specifically heaters for vapour generation devices.

### BACKGROUND

Vapour generating devices, such as electronic cigarettes, are becoming increasingly popular consumer products.

Heating devices for vaporisation or aerosolisation are known in the art. Such devices typically include a heater arranged to heat a vaporisable product. In operation, the vaporisable product is heated with the heater to vaporise the constituents of the product for the consumer to inhale. In some examples, the product may comprise tobacco in a capsule or may be similar to a traditional cigarette, in other examples the product may be a liquid, or liquid contents in a capsule.

There is a need to improve the experience of the consumer of such products; an object of the present invention is to address this need by improving the quality of the vapour flow. There is also a need to improve heater operation; another object of the invention is to address this.

### SUMMARY

According to a first aspect there is provided a heater device for an electronic cigarette comprising a heater unit housing a vaporising chamber and arranged to vaporise a liquid received from a liquid reservoir and generate a vapour. A vapour flow path extends from the vaporising chamber arranged to fluidly communicate with a mouthpiece of an electronic cigarette to allow the generated vapour to flow from the vaporising chamber to the mouthpiece. The heater unit comprises a plurality of through-channels arranged to allow the generated vapour to flow from the vaporising chamber to the vapour flow path. The through-channels may reduce randomised motion of the vapour particles as the vapour flows along the vapour flow path to the mouthpiece, which may provide a smoother vapour to the user. Passing the vapour through the through-channels may maximise the flow rate of the vapour through the heater device by reducing zig-zag flow within the heater device. To improve the sensory experience of the user it is advantageous that there is an even distribution of the produced droplets in the inhaled airflow. Therefore providing through-channels which help homogenising the output from the heater device will help improve the experience of the user.

The through-channels may form part of the vapour flow path. This ensures that the vapour flows through the through-channels before it reaches the mouthpiece.

Preferably, the through-channels act as a filter arranged to filter the generated vapour as it flows from the vaporising chamber to the vapour flow path. Filtering the vapour before it reaches the mouthpiece may help to optimise the vapour droplet size distribution, such that the droplet size is more consistent throughout the vapour. This may result in more homogenous vapour delivery to the user. A more consistent vapour to be inhaled by the user may improve the mouthfeel of the vapour and the overall user experience when using the heater device.

In some examples, the diameter of all the through-channels in the plurality of through-channels is substantially the same. This may ensure that the vapour droplets which pass through the through-channels are substantially all the same size, providing a more consistent vapour for the user to inhale. In other examples, the diameter of all the through-channels in the plurality of through-channels may be different. This may allow vapour droplets having different sizes to pass through the filter. This may be allow different types of aerosol generating liquid to be used, which may produce vapours having different sized droplets.

Preferably, the heater unit comprises a first heating portion and a second heating portion. The first heating portion may be arranged to vaporise liquid received from a reservoir of an electronic cigarette and generate a vapour.

The vaporising chamber may be arranged between the first and second heating portions. The vaporising chamber may be further arranged to receive the generated vapour from the first heating portion. Separating the first and second heating portions provides sufficient space for a vapour to be collected and temporarily stored.

The second heating portion is preferably arranged to receive the generated vapour from the vapour chamber and further preferably arranged to heat the generated vapour. The generated vapour is therefore reheated by the second heating portion. Since the initially generated vapour is typically a cold vapour, there is a risk of the vapour condensing within the heater device before it can be inhaled by the user. Condensed vapour with the heater device increase the risk of leaks and short circuits within the heater device, which is dangerous. By reheating the vapour, the risk of the vapour condensing before it reaches the user is reduced. Thus the chance of leakage and short circuits with the heater device is also reduced. Additionally, reheating the vapour helps control the size of the droplets within the generated vapour, in particular the size of the droplets will be more consistent throughout the vapour. Thus, reheating the generated vapour leads to improved droplet size distribution which helps provide a more homogenous vapour to the user. Furthermore, reheating the generated vapour improves the heating efficiency of the heater device, which may reduce the amount of energy required to be supplied to the heater device.

The plurality of through-channels may form part of the second heating portion.

The vapour flow path may comprise a first vapour flow portion and a second vapour flow portion. The first vapour flow portion may extend between the vaporising chamber and the second heating portion. The second vapour flow portion may extend from the second heating portion and may be arranged to fluidly communicate with a mouthpiece of an electronic cigarette.

Preferably the first vapour flow portion and the second vapour flow portion are arranged substantially in line with each other such that vapour flowing from the first vapour flow portion to the second vapour flow portion follows a substantially straight flow path having substantially linear flow. Smooth particle flow between the first and second heating portions helps improve the efficiency of the second heating portion as the vapour is able to flow towards the second heating portion in a substantially direct manner, from the first heating portion, and so less energy has been lost as the vapour travels between the first and second heating portions. This linear configuration provides helps control the flow of vapour within the heater device.

Alternatively, the first vapour flow portion and the second vapour flow portion may be arranged in an offset manner from each other such that vapour flowing from the first vapour flow portion to the second vapour flow portion changes direction as it flows between the first and second vapour flow portions. Providing an offset between the first and second vapour flow portions has the effect of increasing the overall length of the vapour flow path. As such, the vapour flowing within the vapour flow path takes longer to reach the mouthpiece from the heater unit. This increased flow distance reduces the temperature of the vapour before it reaches the mouthpiece, which Reduces the chance of the user inhaling vapour which may be too hot. In addition, the increased length of the vapour flow path reduces audible noises experienced by the user, and which are produced by the heater device.

In some examples, the first and second vapour flow portions may form a U-shaped vapour flow path. In other examples, the first and second vapour flow portions may form a zig-zag-shaped vapour flow path.

The heater device may comprise an air inflow path extending between an air inlet and the heater unit. The air inflow path allows air to enter into the heater unit.

Preferably, the generated vapour is delivered to the second heating portion from the first heating portion under the action of air which has entered the air inlet and flowed along the airflow path via the air inflow path. The air flowing into the heater device therefore acts to direct the generated vapour from the first heating portion to the second heating portion. This ensures that the generated vapour is re-heated by the second heating portion before it reaches the mouthpiece. Using the action of air flowing into the heater device to direct the generated vapour provides a simple mechanism for directing the generated vapour, without the need for additional components. Thus reduces the complexity of the overall heater device, making it cheaper to manufacture.

According to a second aspect there is provided a capsule for an electronic cigarette, the capsule having a first end configured to engage with an electronic cigarette device and a second end arranged as a mouthpiece portion having a vapour outlet. The capsule further comprises a reservoir arranged to store a liquid to be vaporised, and a heater unit housing a vaporising chamber and arranged to vaporise a liquid received from the reservoir and generate a vapour. A vapour flow path extends between the vaporising chamber and the mouthpiece to allow the generated vapour to flow from the vaporising chamber to the mouthpiece. The heater unit comprises a plurality of through-channels arranged to allow the generated vapour to flow from the vaporising chamber to the vapour flow path.

There may be provided a capsule for use with a vapour generating device, the capsule comprising the heater device, and any of its modifications, as described herein. In this way, the heater device can form part of a consumable capsule and can be replaceable in a vapour generation device. In particular, this can be beneficial when changing to a vaporisable substance of a different flavour, in a new capsule, as a new heater unit would be used and the generated vapour would not be contaminated with residual flavouring from the previous vaporisable substance.

According to a third aspect there may be provided an electronic cigarette comprising a main body and a capsule wherein the main body comprises a power supply unit, electrical circuitry, and a capsule seating configured to connect with the capsule. The capsule comprises a first end configured to engage with the electronic cigarette device and a second end arranged as a mouthpiece portion having a vapour outlet. The capsule further comprises a reservoir arranged to store a liquid to be vaporised, and a heater unit housing a vaporising chamber and arranged to vaporise a liquid received from the reservoir and generate a vapour. A vapour flow path extends between the vaporising chamber and the mouthpiece to allow the generated vapour to flow from the vaporising chamber to the mouthpiece. The heater unit comprises a plurality of through-channels arranged to allow the generated vapour to flow from the vaporising chamber to the vapour flow path.

There may be provided a vapour generating device comprising the heater device, and any of its modifications, as described herein.

### BRIEF DESCRIPTION OF DRAWINGS

Embodiments of the invention are now described, by way of example, with reference to the drawings, in which:

FIG. 1 is a conceptual cross-sectional view of a portion of a vaporisation component for a vapour generation device;

FIG. 2 is a conceptual cross-sectional view of a vaporisation component integrated into a portion of a vapour generation device;

FIG. 3 is a conceptual cross-sectional view of a vaporisation component; and

FIG. 4 is a conceptual cross-sectional view of another vaporisation component.

### DETAILED DESCRIPTION

A vapour generation device is a device arranged to heat a vapour generating product to produce a vapour for inhalation by a consumer. In a specific example, a vapour generating product can be a liquid which forms a vapour when heated by the vapour generation device. A vapour generation device can also be referred to as an electronic cigarette or aerosol generation device. In the context of the present disclosure, the terms vapour and aerosol can be used interchangeably. A vapour generating product, or aerosol generating product, can be a liquid or a solid such as a fibrous material, or a combination thereof, that when heated generates a vapour or aerosol.

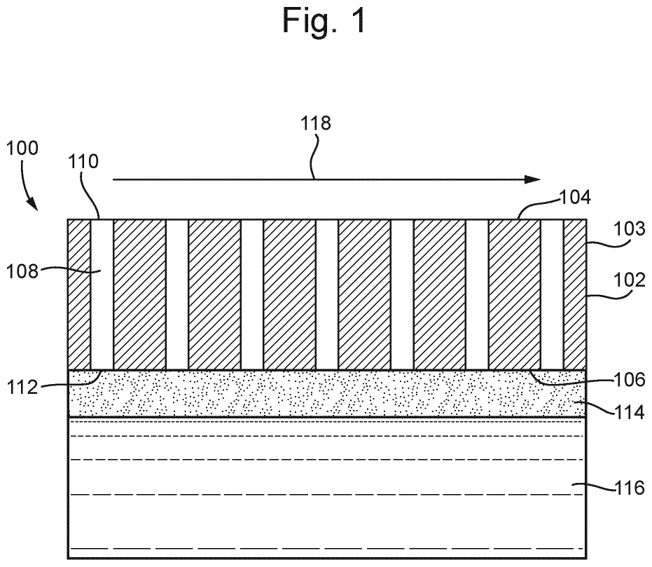

FIG. 1 shows a cross-sectional diagram of a portion of a vaporisation component 100 for a vapour generation device. In this case, the vaporisation component 100 is a heater device 100.

The vaporisation component 100 comprises an evaporator component 102, housing a vaporising chamber, arranged to vaporise a liquid received from a liquid reservoir and generate a vapour, and a vapour flow path 128 extending from the vaporising chamber arranged to fluidly communicate with a mouthpiece of the vapour generation device to allow the generated vapour to flow from the evaporator component 102, in particular the vaporising chamber, to the mouthpiece. The evaporator component 102 may also be referred to as a heater unit 102.

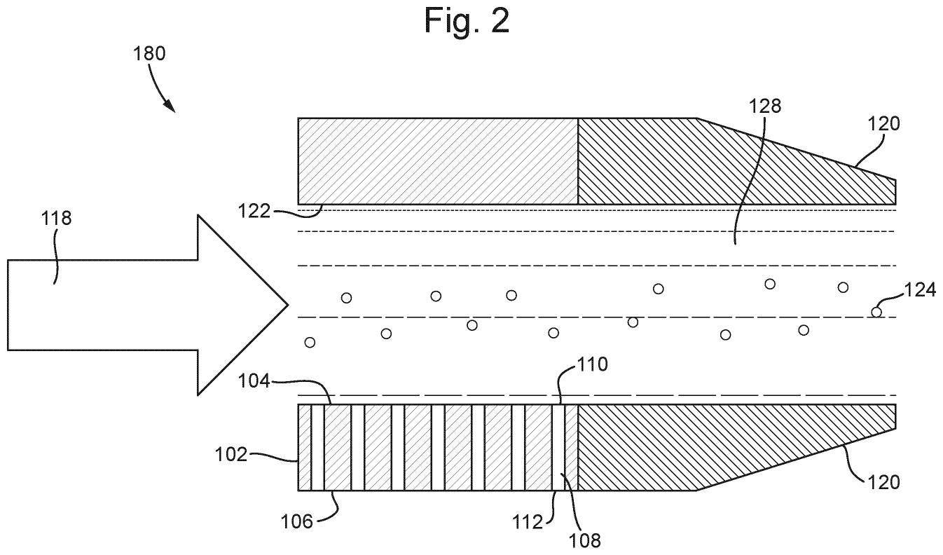

The heater device 100 is in fluid communication with a reservoir which is arranged to store a liquid vapour generating product. The evaporator component 102 (hereinafter referred to as the heater unit) can be considered as an evaporator block or heater, and in an example can be formed from silicon. FIG. 2 shows a conceptual cross-sectional diagram of the heater unit 102 integrated into a portion 180 of a vapour generation device.

The heater unit 102 has a first heating portion 103 comprising a first surface 104 and a second surface 106. The first surface 104 faces toward the vapour flow path 128 of the vapour generation device. The first surface 104 therefore provides fluid communication between the vaporising chamber and the mouthpiece via the vapour flow path 128, which allows vapour to flow from the vaporising chamber into the vapour flow path and to the mouthpiece. The vapour flow path 128, which may also be referred to as an airflow channel 128 of the vapour generation device, is a channel through which air flows substantially in a direction 118 towards the mouthpiece 120 when a consumer draws upon the mouthpiece 120. In other words, the airflow channel 128 connects air inlets (not shown) within the vapour generation device to the mouthpiece 120 for the passage of air through the vapour generation device. The airflow channel 128 is arranged to transport generated vapour to the mouthpiece 120 through which the vapour is inhaled by a user. The first surface 104 of the heater unit 102 can be arranged in the airflow channel 128, and in the example of FIGS. 1 and 2 can form a portion of an internal sidewall of the airflow channel 128. The cross-section of FIGS. 1 and 2 are viewed along a direction perpendicular to the direction along the airflow channel 128 toward the mouthpiece 120.

In an example, the heater unit 102 can be a micro-electro-mechanical system (MEMS) evaporator; this evaporator can be silicon-based at least in part.

The second surface 106 is on a separate face to the first surface 104. In the example of FIGS. 1 and 2 the second surface 106 is spaced apart from the first surface 104, on an opposing face to the first surface 104. The second surface 106 of the heater unit 102 is arranged to be in fluid communication with the reservoir 116. This means that the second surface 106 provides fluid communication between the reservoir 116 and the vaporising chamber allowing fluid to flow from the reservoir into the vaporising chamber.

A plurality of channels 108 are arranged through the heater unit 102 to connect a set of first openings 110 in the first surface 104 to a corresponding set of second openings 112 in the second surface 106. That is, each of these channels 108 is a through-hole that passes through the heater unit 102, and so the channels 108 may also be referred to as primary through-channels 108. The primary through-channels are arranged such that one end of each primary through-channel 108 forms a first opening 110 in the first surface 104 and the other end of each primary through-channel 108 forms a second opening 112 in the second surface 106. These primary through-channels 108 can be in an array type arrangement and are of micrometre scale.

The primary through-channels 108 are arranged to draw liquid from the reservoir 116 through the second openings 112, through the primary through-channels 108, and to the first openings 110 by capillary force.

Any suitable number of primary through-channels 108, with corresponding numbers of first 110 and second openings 112, can be arranged in the heat unit 102. In some examples there may be one primary through-channel 108. Alternatively, there may be a plurality of primary through-channels 108. In this case, the diameter of all the primary through-channels 108 in the plurality of through-channels is substantially the same. However, in other examples, the diameter at least one of the primary through-channels 108 in the plurality of primary through-channels 108 may be different from the diameter of the other primary through-channels 108.

The primary through-channels 108 can provide a filtering function, acting to filter the liquid and some of the generated vapour as it flows from the heater unit 102 into the airflow channel 128. This is because a particular channels size or diameter can selectively pass liquids with different fluid properties from the reservoir through the heater unit 102 via the primary through-channels 108, for example due to different surface tensions of these liquids.

The primary through-channels 108 pass through the first surface 104 and so the first surface 104 may be considered as comprising a filter, which filters the generated vapour as it flows from the primary through-channels 108 to the vapour flow path 128.

In some examples, an optional wicking material 114 can be incorporated into the heater device 100, and in particular can be arranged between the second surface 106 of the heater unit 102 and the reservoir 116. The wicking material 114 can aid in the transfer of liquid from the reservoir 116 to the second openings 112 in the second surface 106. In this way, the reservoir 116 can either be in direct connection with the second surface 106 of the heater unit 102, or in indirect connection with the second surface 106 by way of the wicking material 114.

For clarity, only the heater unit 102 of the heater device 100 is shown in FIG. 2;

the reservoir 116 and optional wicking material 114 are not shown but can readily be included.

Generally in operation, liquid is drawn from the reservoir 116 into the second openings 112 in the second surface 106 of the heater unit 102. The liquid then travels into and through the primary through-channels 108 by capillary action. A potential is applied to the heater unit 102 by a heater control circuit (not shown) so as to heat the heater unit 102. In turn the heater unit 102 heats the liquid through the sidewalls of the primary through-channels 108, as the liquid is drawn through the primary through-channels 108, to create a vapour. The primary through-channels 108 therefore perform the function of the previously mentioned vaporising chamber. As such the primary through-channels 108 can be considered to be at least part of the vaporising chamber. The vapour then exits the primary through-channels 108 as a vapour flow through the first openings 110 in the first surface 104 and enters the airflow channel 128 of the vapour generation device. This vapour flow can also include liquid droplets 124 from the primary through-channels 108. The primary through-channels 108 therefore allow the generated vapour to flow from the heater unit 102 to the airflow channel 128, and so the primary through-channels 108 can be considered to form part of the airflow channel 128.

In the example of FIG. 2, the first surface 104 of the heater unit 102 partially defines an internal wall of the airflow channel 128. The airflow channel 128 can be considered as a tube or passageway, defined by internal walls, through which the air and vapour travels to the mouthpiece 120. An opposing internal wall 122 of the airflow channel is also shown in FIG. 2. The opposing internal wall 122 at least partially forms part of the internal wall of the airflow channel 128 opposite to the first surface 104 of the heater unit 102. Further internal walls, that complete the definition of the airflow channel 128, connect the first surface 104 of the heater unit 102 and the opposing wall 122. For clarity, these further internal walls are not shown in the cut-away section in FIG. 2.

When a user draws on the mouthpiece 120, air is brought into the airflow channel 128 through air inlets (not shown) connected to the airflow channel 128 and located distal from the mouthpiece 120 so as to create a pressure change that draws the generated vapour flow to the mouthpiece 120, in the airflow 118 as it passes over the first surface 104, for inhalation by the user.

For clarity, sections of the body of the vapour generation device are not shown in FIG. 2, including portions containing control electronics, a power source such as a battery, and the electronics connecting the heater unit to the control electronics and power source.

Further details of the structure of the heater unit 102 will now be discussed.

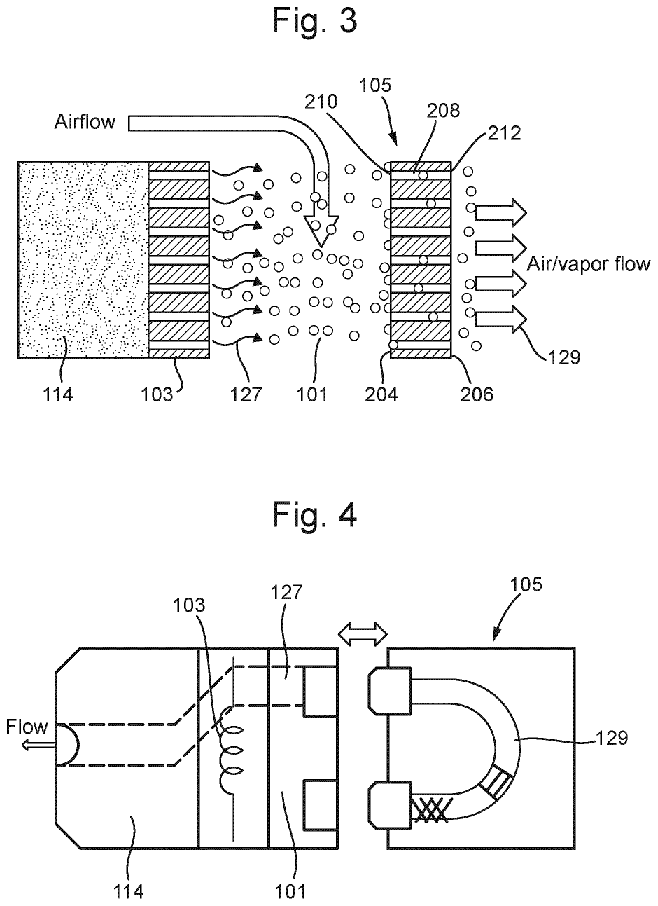

As previously mentioned, the heater unit 102 comprises a first heating portion 103 including the first and second heating surfaces 104, 106. As illustrated in FIG. 3, the heater unit 102 additionally comprises a second heating portion 105. The first heating portion 103 and second heating portion 105 are arranged next to each and spaced apart from each other. In particular, the vaporising chamber 101 is arranged between the first and second heating portions 103, 105 such that the vaporising chamber 101 is arranged to receive the generated vapour from the first heating portion 103.

As has already been explained, the first heating portion 103 is arranged to heat liquid received from the reservoir 116 of an electronic cigarette to generate a vapour. The second heating portion 105 is arranged to receive the generated vapour from the vaporising chamber 101 and heat the vapour generated by the first heating portion 103.

As shown in FIG. 3, the second heating portion 105 has a similar construction to the first heating portion 103 in that it comprises a first surface 204 and a second surface 206.

The first surface 104 faces toward the vaporising chamber 101 and allows fluid communication between the vaporising chamber 101 and the second heating portion 105. The second surface 206 is on a separate face to the first surface 204, spaced apart from the first surface 204, and on an opposing face to the first surface 204. The second surface 206 provides fluid communication between the second heating portion 105 and the mouthpiece via the vapour flow path 128, as shown in FIG. 3.

A plurality of channels 208 are arranged through the second heating portion 105, connecting a set of first openings 210 in the first surface 204 to a corresponding set of second openings 212 in the second surface 206. Thus, each channel 108 is a through-hole that passes through the second heating portion 105, and so the channels 108 may also be referred to as secondary through-channels 208. The secondary through-channels 208 are arranged in a similar manner to the primary through channels 108 such that one end of each secondary through-channel 208 forms a first opening 210 in the first surface 204 and the other end of each secondary through-channel 208 forms a second opening 212 in the second surface 206. The secondary through-channels 208 can be in an array type arrangement and are of micrometre scale.

In some examples each primary through-channel 108 has a corresponding secondary through-channel 208, and so there are the same number of primary and secondary through-channels. However in other examples there may be different numbers of primary and secondary through channels. For example there may be more primary through-channels 108 than secondary through-channels 208, or vice versa. Further, in some developments, the primary through-channels 108 may be substantially the same size as the secondary through channels 208. However in other developments, the primary through-channels 108 may have a different size to the secondary through channels 208. For example, the primary through-channels 108 may have a larger diameter than the secondary through-channels 208.

The secondary through-channels 208 are arranged to allow vapour to flow from the vaporising chamber 101 through the second openings 212, through the through-channels 208, and to the first openings 210 by capillary force.

As before, the secondary through-channels 208 provide a filtering function, acting to filter the generated vapour as it flows from the vaporising chamber 101 into the airflow channel 128. Again, different channel sizes can selectively pass liquids with different fluid properties through the second heating portion 105.

The secondary through-channels 208 pass through the first surface 204 and so the heater unit 102, in particular the second heating portion 105 may be considered as comprising a second filter, which filters the generated vapour as it flows from the secondary through-channels 208 to the vapour flow path 128. The secondary through-channels 208 therefore comprise part of the vapour flow path 128.

The first heating portion 103 provides a vaporising or evaporating function and so the first heating portion 103 can be thought of as an evaporator with primary through-channels 108. The second heating portion 105 provides a reheating function and so the second heating portion 105 can be thought of as a reheater with secondary through channels 208. Both the first and second heating portions provide an additional filtering function.

As illustrated in FIGS. 3, the evaporation surface, which is the first surface 104 of the first heating portion 103, faces the second heating portion 105. Generally, during use, aerosol particles that have been vaporised, or evaporated, by the evaporation surface are delivered to the reheater 105 by the action of air flowing into the heater device 100 from the air inlets in the distal end of the heater device 100. The heater device 100 therefore includes an air inflow path that extends between the air inlets and the heater unit 102, allowing air to enter the heater device 100 and flow toward the heater unit 102.

The generated vapour is delivered to the second heating portion 105 from the first heating portion 103 under the action of air which has entered the air inlets and flowed along the air inflow path and into the vapour flow path 128. This is illustrated by the airflow arrow in FIG. 3.

The vapour flow path 128 can be thought of as comprising a first vapour flow portion 127 and a second vapour flow portion 129. The first vapour flow portion 127 extends between the vaporising chamber 101 and the second heating portion 103, and the second vapour flow portion 129 extends from the second heating portion 105 and is arranged to fluidly communicate with the mouthpiece of an electronic cigarette.

The vapour generated by the first heating portion 103 is arranged to flow through the second heating portion 105 before flowing towards the mouthpiece along the second vapour. Thus the generated vapour is therefore reheated by the second heating portion 105 before it reaches the mouthpiece.

The first heating portion 103 will generally produce a relatively cold aerosol, or vapour, meaning that it is likely to condense on the walls of the vapour flow path 128 as it travels from the heater unit 102 to the mouthpiece. This can lead to an accumulation of liquid within the heater device 100 which can lead to leakage. This can be dangerous as it can lead to short circuits and malfunctioning of the heater device 100.

Instead, by providing a second heating zone, such as the reheating zone provided by the second heating portion 105, the aerosol can be additionally heated, increasing its temperature, which reduces the chance of the aerosol condensing on the internal walls of the vapour flow path 128 as it flows towards the mouthpiece. A further advantage of reheating the aerosol is that the droplet size can be more accurately controlled. In particular, larger particles which are initially unable to pass through the secondary through-channels 208 condense on the first surface 204 of the second heating portion 105 and are reheated to produce smaller, finer particles. The smaller particles can then pass through the secondary through-channels 208. Thus, reheating the aerosol reduces the size of the droplets, providing a smoother aerosol which has a more pleasant mouthfeel for the user.

The heater unit 102 described herein is arranged to maximise the flow rate of the vapour and maintain a steady consistency of droplet size, by reheating the vapour before it reaches the mouthpiece. In order to improve the sensory experience of the user it is advantageous that there is an even distribution of the produced droplets in the inhaled airflow. Therefore providing a heater unit 102 which homogenises the output from the heater device 100 will improve the experience of the user.

More specifically, the first heating portion 103 is configured to sufficiently heat the liquid received from the reservoir in order to first excite the liquid to its enthalpy of vaporisation and it starts to vaporise. The second heating portion 105 further excites the vapour and the air-pressure resulting from the user inhaling sucks through only particles having a droplet size that are of sufficient size to pass through the secondary through-channels 208. This makes the particle sizes on the output of the second heating portion 105 substantially consistent and of substantially the same size as the secondary through-channels, which have been optimally sized. By optimally sized, we mean that the size (for example the diameter) of the secondary through-channels 208 has been chosen so that the particles size output from the secondary through-channels 208 corresponds to an optimal particle size for inhalation. The second heating portion therefore acts as a fine sieve which filters out randomised droplets from the first-stage to a vapour comprising substantially homogenous sized droplets on the second-stage output. Providing a fluid that is already changing state to the second heating portion 105 allows the second heating portion 105 to work faster. This helps reduce the overall power required to be supplied to the heater unit, and so the device operates more efficiently.

As shown in FIG. 3, the first and second heating portions 103, 105 are arranged substantially in-line with each other. In this configuration the first vapour flow portion 127 and the second vapour flow portion 129 are substantially in line with each other. This has the effect that vapour flowing from the first vapour flow portion 127 to the second vapour flow portion 129 follows a substantially straight flow path having substantially linear flow.

Arranging the first and second heating portions 103, 105 in-line with each other, such that the flow path between the first and second heating portions 103, 105 is substantially linear, helps ensure that only the droplet sizes equal to or less than the channel size of the secondary through-channels 208 can pass through the second heating portion 208 whilst the larger size droplets are reheated. Additionally, placing the first and second heating portions 103, 105 substantially in line with each other helps ensures that the flow is smooth, i.e. straight, without Brownian motion. Smooth particle flow between the first and second heating portions also improves the efficiency of the second heating portion 105 because the vapour particles have been delivered to the second heating portion 105 in a substantially direct manner, from the first heating portion 103, and so less energy has been lost by the particles when the reach the second heating portion 105.

The linear configuration therefore helps improve control of fluid flow within the heater device 100. Further, passing the aerosol through the secondary through-channels helps eliminate random zig-zag motion of the aerosol particles, which may help provide a smoother aerosol.

FIG. 4 shows an alternative configuration in which the first and second heating portions 103, 105 are off-set from each other. In this configuration, the first vapour flow portion 127 and the second vapour flow portion 129 are substantially offset from each other. This has the effect that vapour flowing from the first vapour flow portion 127 to the second vapour flow portion 129 changes direction as it flows between the first and second vapour flow portions.

In some examples, such as the arrangement shown in FIG. 4, the first and second vapour flow portions 127, 129 form a substantially U-shaped vapour flow path 128. In other examples, the first and second vapour flow portions 127, 129 form a substantially zig-zag shaped vapour flow path.

By arranging the first and second vapour flow portions 127, 129 offset with respect to each other, such that the vapour is redirected in some manner as it flows between the first and second vapour flow portions 127, 129, the overall length of the vapour flow path 128 is increased, compared to a linear configuration. The increased distance of the vapour flow path 128 reduces the temperature of vapour delivered to the user through the mouthpiece. Additionally, the increased distance of the vapour flow path 128 reduces the level of audible noise within the heater device 100 and experienced by the user, creating a more pleasant user experience overall.

Further, by arranging the first and second heating portions in an offset manner, for example as shown in FIG. 4, the heater device 100 can be thought of comprising a first stage which includes the first heating portion 103 and a second stage which includes the second heating portion 105. The first stage, also comprising the reservoir, can be designed to be a disposable stage such that the user can dispose of this stage once the liquid in the reservoir has run out. The second stage can be retained and re-connected to a replacement first stage. This provides a more sustainable heater device 100 because only part of the device needs to be replaced when the liquid has run out and so fewer components are disposed of after use.

As the skilled person will appreciate, the heater device 100 described above, and any of its modifications, can be used as part of a capsule for an electronic cigarette. For example, the capsule includes a first end configured to engage with an electronic cigarette device and a second end arranged as a mouthpiece portion having a vapour outlet. The capsule also includes a reservoir arranged to store a liquid to be vaporised and the heater device described above.

The heater device 100 described above, and any of its modifications, can also be used as part of an electronic cigarette. For example, an electronic cigarette comprises a main body and a capsule. The main body has a power supply, electrical circuitry, and a capsule seating. The capsule seating of the main body is arranged to engage with and electrically connect with a first end of the capsule. A second end of the capsule is arranged as a mouthpiece portion having a vapour outlet. The capsule also includes a reservoir arranged to store a liquid to be vaporised and the heater device described above.

In some examples, the heater device 100 such as the heater device 100 of FIG. 1 includes the heater unit 102 and the reservoir 116, and optionally the wicking material 114, which can be formed as a single component. In some examples, the heater device 100 is a component of the vapour generation device, with the reservoir 116 being refillable. In some examples, the heater device 100 (including the heater unit 102, the reservoir 116, and optionally the wicking material 114) can be comprised in a removable capsule for the vapour generation device that can be detached from the vapour generation device (such as when the reservoir 116 is empty of liquid). In this example, the heater device 100 can be a replaceable consumable. Alternatively the reservoir 116 can be refilled. In other examples, the heater unit 102 can be a component of the vapour generation device, and the reservoir 116 (and optionally the wicking material 114) can form a removable component that can be detached from the vapour generation device (such as when the reservoir 116 is empty of liquid).

1. A heater device for an electronic cigarette comprising:
a heater unit housing a vaporising chamber and arranged to vaporise a liquid received from a liquid reservoir to generate a vapour; and
a vapour flow path extending from the vaporising chamber arranged to fluidly communicate with a mouthpiece of an electronic cigarette to allow the generated vapour to flow from the vaporising chamber to the mouthpiece;
wherein the heater unit comprises a plurality of through-channels arranged to allow the generated vapour to flow from the vaporising chamber to the vapour flow path; and
wherein the heater unit is arranged to heat the liquid through sidewalls of the plurality of through-channels, as the liquid is drawn through the through-channels, to generate the vapour.

2. The heater device according to claim 1 wherein the through-channels form part of the vapour flow path.

3. The heater device according to claim 1 wherein the through-channels act as a filter arranged to filter the generated vapour as the generated vapour flows from the vaporising chamber to the vapour flow path.

4. The heater device according to claim 1 wherein all of the through-channels of the plurality of through-channels have the same diameter.

5. The heater device according to claim 1 wherein the heater unit comprises a first heating portion and a second heating portion, wherein:
the first heating portion is arranged to vaporise the liquid received from the liquid reservoir to generate the vapour;
the vaporising chamber is arranged between the first and second heating portions and arranged to receive the generated vapour from the first heating portion; and
the second heating portion is arranged to receive the generated vapour from the vapour chamber and further arranged to heat the generated vapour.

6. The heater device according to claim 5 wherein the plurality of through-channels form part of the second heating portion.

7. The heater device according to claim 5 wherein the vapour flow path comprises a first vapour flow portion and a second vapour flow portion, wherein:
the first vapour flow portion extends between the vaporising chamber and the second heating portion; and
the second vapour flow portion extends from the second heating portion and is arranged to fluidly communicate with the mouthpiece.

8. The heater device according to claim 7 wherein the first vapour flow portion and the second vapour flow portion are substantially in line with each other such that the vapour flowing from the first vapour flow portion to the second vapour flow portion follows a substantially straight flow path having substantially linear flow.

9. The heater device according to claim 7 wherein the first vapour flow portion and the second vapour flow portion are offset from each other such that the vapour flowing from the first vapour flow portion to the second vapour flow portion changes direction as it flows between the first and second vapour flow portions.

10. The heater device according to claim 9 wherein the first and second vapour flow portions are arranged such that the vapour flow path has a U-shape.

11. The heater device according to claim 9 wherein the first and second vapour flow portions are arranged such that the vapour flow path has a zig-zag shape.

12. The heater device according to claim 1 further comprising an air inflow path extending between an air inlet and the heater unit for allowing air to enter into the heater unit.

13. The heater device according to claim 12 wherein the generated vapour is delivered to the second heating portion from the first heating portion under the action of air which has entered the air inlet and flowed along the airflow path.

14. A capsule for an electronic cigarette, the capsule having a first end configured to engage with an electronic cigarette device and a second end arranged as a mouthpiece portion having a vapour outlet, the capsule further comprising:
a reservoir arranged to store a liquid to be vaporised;
a heater unit housing a vaporising chamber and arranged to vaporise the liquid received from the reservoir to generate a vapour; and
a vapour flow path extending between the vaporising chamber and the mouthpiece to allow the generated vapour to flow from the vaporising chamber to the mouthpiece;
wherein the heater unit comprises a plurality of through-channels arranged to allow the generated vapour to flow from the vaporising chamber to the vapour flow path; and
wherein the heater unit is arranged to heat the liquid through sidewalls of the plurality of through-channels, as the liquid is drawn through the through-channels, in order to generate the vapour.

15. An electronic cigarette comprising a main body and a capsule wherein the main body comprises a power supply unit, electrical circuitry, and a capsule seating configured to connect with the capsule, the capsule comprising:
a first end configured to engage with the electronic cigarette device and a second end arranged as a mouthpiece portion having a vapour outlet, the capsule further comprising:
a reservoir arranged to store a liquid to be vaporised;
a heater unit housing a vaporising chamber and arranged to vaporise a liquid received from the reservoir and generate a vapour; and
a vapour flow path extending between the vaporising chamber and the mouthpiece to allow the generated vapour to flow from the vaporising chamber to the mouthpiece;
wherein the heater unit comprises a plurality of through-channels arranged to allow the generated vapour to flow from the vaporising chamber to the vapour flow path; and
wherein the heater unit is arranged to heat the liquid through sidewalls of the plurality of through-channels, as the liquid is drawn through the through-channels, to generate the vapour.
